(19) United States
(12) Patent Application Publication
(10) Pub. No.: US 2005/0031984 A1
(43) Pub. Date: Feb. 10, 2005

(54) Chemical amplification type positive resist composition

(75) Inventors: Yoshiyuki Takata, Toyonaka-shi (JP); Youngjoon Lee, Toyonaka-shi (JP); Koshiro Ochiai, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/694,719

(22) Filed: Oct. 29, 2003

(30) Foreign Application Priority Data
Oct. 30, 2002 (JP) 2002-315517

(51) Int. Cl. G03C 1/76

(52) U.S. Cl. 430/270.1

(57) ABSTRACT

The present invention provides a resin which comprises a structural unit of the formula (I) 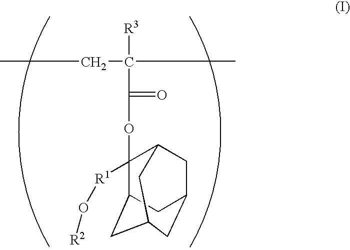
wherein R¹ represents alkylene having 1 to 4 carbon atoms, R² represents alkyl having 1 to 4 carbon atoms, and R³ represents hydrogen or methyl, and also prvides a chemical amplification type positive resist composition comprising a resin defined above and an acid generator.

### BACKGROUND OF THE INVENTION

1. Field of the Invention

The present invention relates to a chemical amplification type positive resist composition used in fine processing of semiconductors and also provides a novel resin useful for the resist composition.

2. Related Art

Semiconductor microfabrication employs a lithography process using a resist composition. In lithography, theoretically, the shorter the exposure wavelength becomes, the higher the resolution can be made, as expressed by Rayleigh's diffraction limit formula. The wavelength of an exposure light source for lithography used in the manufacture of semiconductor devices has been shortened year by year as g line having a wavelength of 436 nm, i line having a wavelength of 365 nm, KrF excimer laser having a wavelength of 248 nm and ArF excimer laser having a wavelength of 193 nm. F₂ excimer laser having a wavelength of 157 nm seems to be promising as the next-generation exposure light source. Further, as the exposure light source of the subsequent generation, soft X ray (EUV) having a wavelength of 13 nm or shorter has been proposed as the exposure light source following the 157 nm-wavelength F₂ excimer laser.

Since light sources having shorter wavelength than that of g line and i line, such as excimer laser and the like have low illumination, it is necessary to enhance the sensitivity of a resist. Consequently, there are used so-called chemical amplification type resists utilizing the catalytic action of an acid produced from a sulfonium salt and the like by exposure and containing a resin having a group being dissociated by this acid.

For further reduction of exposure time, chemical amplification type resist composition is required to have higher sensitivity than conventionally known compositions.

### SUMMARY OF THE INVENTION

An object of the present invention is to provide a novel resin and to provide a chemical amplification type resist composition comprising the above-mentioned resin and an acid generator, and suitable for excimer laser lithography using ArF, KrF and the like, showing excellent various resist abilities, and giving particularly improved sensitivity.

The present invention relates to the followings:

<1> A resin which comprises a structural unit of the formula (I) 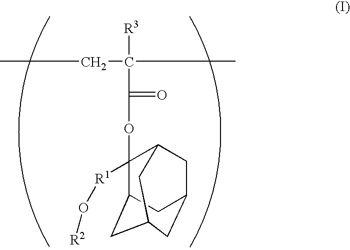
wherein R¹ represents alkylene having 1 to 4 carbon atoms, R² represents alkyl having 1 to 4 carbon atoms, and R³ represents hydrogen or methyl.

<2> A chemical amplification type positive resist composition comprising a resin which comprises a structural unit of the formula (I) and which itself is insoluble or poorly soluble in an alkali aqueous solution but becomes soluble in an alkali aqueous solution by the action of an acid, and an acid generator.

<3> The composition according to <2> wherein the content of the structural unit of the formula (I) in all structural units of the resin is from 10 to 80% by mol.

<4> The composition according to <2> or <3> wherein the resin contains, in addition to the structural unit of the formula (I), further at least one structural unit selected from the group consisting of a structural unit derived from 3-hydroxy-1-adamantyl (meth)acrylate, a structural unit derived from 3,5-dihydroxy-1-adamantyl (meth)acrylate, a structural unit derived from (meth)acryloyloxy-γ-butyrolactone having a lactone ring optionally substituted by alkyl, a structural unit of the formula (IIa) and a structural unit of the following formula (IIb) 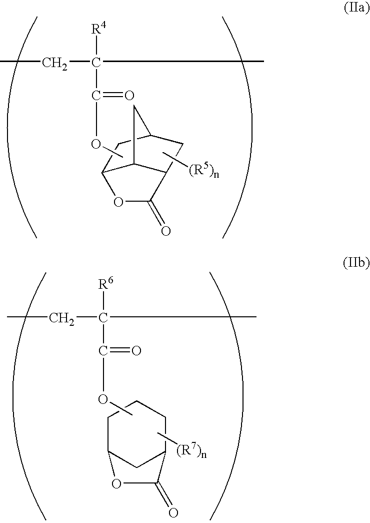
wherein R⁴ and R⁶ each independently represent hydrogen or methyl, R⁵ and R⁷ represent methyl, n represents an integer of 0 to 3.

<5> The composition according to any one of <2> to <4> wherein the resin further contains a structural unit derived from 2-norbornene and a structural unit derived from an aliphatic unsaturated dicarboxylic anhydride.

<6> The composition according to any one of <2> to <5> wherein the acid generator is the one selected from the group consisting of a sulfonium salt of the formula (IIIa) 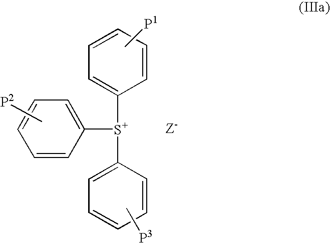
wherein P1 to P3 each independently represent hydrogen, hydroxyl, alkyl having 1 to 6 carbon atoms or alkoxy having 1 to 6 carbon atoms, and Z⁻ represents counter anion,
an iodonium salt of the formula (IIIb) 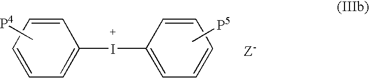
wherein P4 and P5 each independently represent hydrogen, hydroxyl, alkyl having 1 to 6 carbon atoms or alkoxy having 1 to 6 carbon atoms, and Z⁻ represents the same meaning as defined above, or a sulfonium salt of the formula (IIIc) 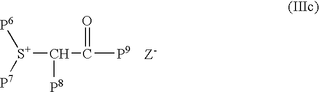
wherein p⁶ and p⁷ each independently represent alkyl having 1 to 6 carbon atoms or cycloalkyl having 3 to 10 carbon atoms, or p⁶ and p⁷ bond to form divalent acyclic hydrocarbon having 3 to 7 carbon atoms which form a ring together with the adjacent S⁺, and at least one —CH₂— in the divalent acyclic hydrocarbon may be substituted by —CO—, —O— or —S—; p⁸ represents hydrogen, P⁹ represents alkyl having 1 to 6 carbon atoms, cycloalkyl having 3 to 10 carbon atoms or aromatic ring group optionally substituted, or p⁸ and P⁹ bond to form 2-oxocycloalkyl together with the adjacent —CHCO—, and Z⁻ represents the same meaning as defined above.

<7> The composition according to <6> wherein Z⁻ is an anion of the formula (IV) 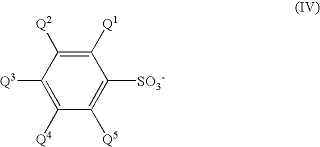
wherein Q¹, Q², Q³, Q⁴ and Q⁵ each independently represent hydrogen, alkyl having 1 to 16 carbon atoms, alkoxy having 1 to 16 carbon atoms, halogen, aryl having 6 to 12 carbon atoms, aralkyl having 7 to 12 carbon atoms, cyano, sulfide, hydroxyl, nitro or a group of the formula (I′)
—COO—X—Cy¹ (I′)
wherein X represents alkylene and at least one —CH₂— in the alkylene may be substituted by —O— or —S—, and Cy¹ represents alicyclic hydrocarbon having 3 to 20 carbon atoms.

<8> The composition according to any one of <2> to <7> wherein the content of the resin is 80 to 99.9% by weight and the content of the acid generator is 0.1 to 20% by weight based on the total amount of the resin and the acid generator.

<9> The composition according to any one of <2> to <8> wherein the composition further comprises basic nitrogen-containing organic compound as a quencher.

<10> The composition according to <9> wherein the content of the basic nitrogen-containing organic compound is 0.001 to 1 part by weight per 100 parts by weight of the resin.

### DESCRIPTION OF PREFERRED EMBODIMENTS

The present composition comprises (1) a resin which compres a structural unit of the formula (I): 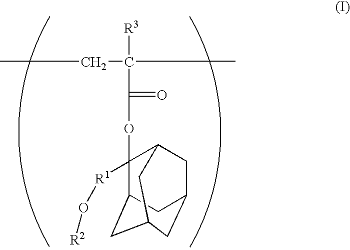
wherein R¹ represents alkylene having 1 to 4 carbon atoms, R² represents alkyl having 1 to 4 carbon atoms, and R³ represents hydrogen or methyl and which itself is insoluble or poorly soluble in an alkali aqueous solution but becomes soluble in an alkali aqueous solution by the action of an acid (hereinafter referred to as “Resin Component”, and (2) an acid generator.

In the formula (I), R¹ represents alkylene having 1 to 4 carbon atoms. Examples thereof include methylene, ethylene, propylene, butylene, 1-methylethylene, 2-methylethylene, 1,2-dimethylethylene, 1-ethylethylene, 2-ethylethylene, 1-methylpropylene, 2-methylpropylene, 3-methylpropylne, ethylidene, propylidene, buthylidene, and the like. R² represents alkyl having 1 to 4 carbon atoms. Examples thereof include methyl, ethyl, propyl, isopropyl, butyl, isobutyl, sec-butyl, tert-butyl, and the like. R³ represents hydrogen or methyl.

Resin Component comprises the structural unit of the formula (I) and other structural unit may be contained as long as Resin Component itself is insoluble or poorly soluble in an alkali aqueous solution but becomes soluble in an alkali aqueous solution by the action of an acid.

Resin Component can be produced by polymerizing monomer of the formula (I′) 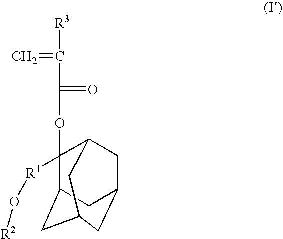
wherein R¹, R² and R³ have the same meanings as defined above, or copolymerizing monomers containing the monomer of the formula (I′).

The monomer of the formula (I′) can be produced, for example, by the following procedures:

Firstly, alkoxylalkyl halide (Cl, Br, and I as halide) are reacted with lithium or magnesium to obtain alkylating agent, and then, 2-adamantanone is reacted with the alkylating agent above to obtain 2-(4-methoxybutanyl)-2-adamantanol. Then, intended monomer can be obtained by reacting 2-(4-methoxybutanyl)-2-adamantanol with (meth)acryloyl chloride in the presence of 1-methylpyridine.

Specific examples of the monomer of the fomula (I′) include the followings:

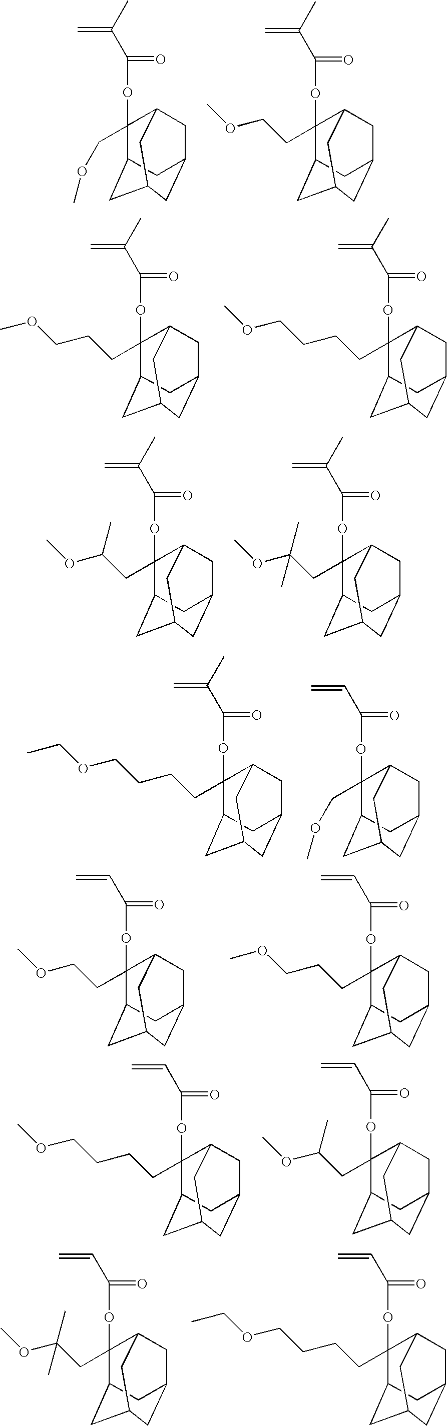

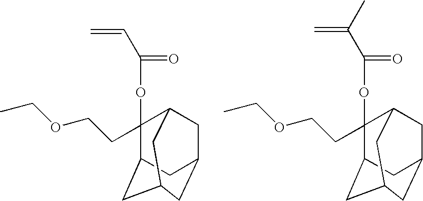

Resin Component may be a copolymer comprising other structural unit having acid-labile group derived from other known monomer(s) in addition to the structural unit of the formula (I). Such acid-labile group may be selected from the various group known as a protective group which itself has ability to suppress dissolution of resin in alkali aqueous solution.

Specific examples of such group include tert-butyl; a group in which a quaternary carbon bonds to oxygen atom such as tert-butoxycarbonyl, tert-butoxycarbonylmethyl, and the like; an acetal type group such as tetrahydro-2-pyranyl, tetrahydro-2-furyl, 1-ethoxyethyl, 1-(2-methylpropoxy)ethyl, 1-(2-methoxyethoxy)ethyl, 1-(2-acetoxyethoxy)ethyl, [2-(1-adamantyloxy)ethoxy]ethyl, 1-[2-(1-adamantanecarbonyloxy)ethoxy]ethyl, and the like; a residue of alicyclic compound such as 3-oxocyclohexyl, 4-methyltetrahydro-2-pyron-4-yl, which is introduced from mevalonic lactone, 2-methyl-2-adamantyl, 2-ethyl-2-adamantyl, and the like.

Hydrogen of phenolic hydroxyl or of carboxyl in the resin is substituted with the acid-labile group. The acid-labile group can be introduced into alkali soluble resin having phenolic hydroxyl or carboxyl by any conventional substituent introduction reaction to obtain the resin used in the present composition. Resin Component can also be obtained by copolymerization of an unsaturated compound having the acid-labile group above as one of monomers in addition to the monomer of the formula (I′).

Resin Component can also contain, other structural units not dissociated or not easily dissociated by the action of an acid. Examples of such other structural units which can be contained include structural units derived from monomers having a free carboxyl group such as acrylic acid and methacrylic acid, structural units derived from aliphatic unsaturated dicarboxylic anhydrides such as maleic anhydride and itaconic anhydride, structural unit derived from 2-norbornene, structural unit derived from (meth)acrylonitrile, structural unit derived from other (meth)acrylates, and the like.

In the case of KrF exposure, there is no problem on light absorption, and a structural unit derived from hydroxystyrene can be further contained.

Particularly, to contain, in addition to the structural unit of the formula (I), further at least one structural unit selected from the group consisting of a structural unit derived from 3-hydroxy-1-adamantyl (meth)acrylate, a structural unit derived from 3,5-dihydroxy-1-adamantyl (meth)acrylate, a structural unit derived from (meth)acryloyloxy-γ-butyrolactone having a lactone ring optionally substituted by alkyl, a structural unit of the following formula (IIa) and a structural unit of the following formula (IIb), in Resin Component, is preferable from the standpoint of the adhesiveness of resist to a substrate.

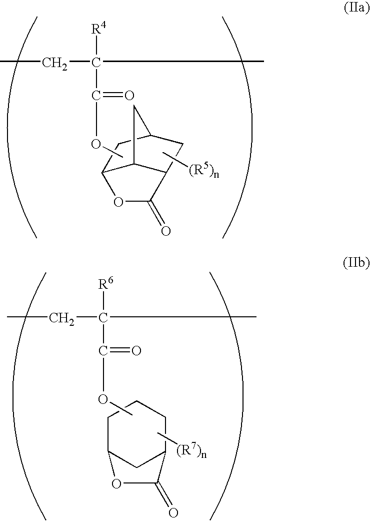

In the formulae (IIa) and (IIb), R⁴ and R⁶ each independently represent hydrogen or methyl, R⁵ and R⁷ represent methyl, n represents an integer of 0 to 3.

3-Hydroxy-1-adamantyl (meth)acrylate and 3,5-dihydroxy-1-adamantyl (meth)acrylate can be produced, for example, by reacting corresponding hydroxyadamantane with (meth)acrylic acid or its acid halide, and they are also commercially available.

Further, (meth)acryloyloxy-γ-butyrolactone can be produced by reacting α- or β-bromo-γ-butyrolactone having a lactone ring optionally substituted by alkyl with acrylic acid or methacrylic acid, or reacting α- or β-hydroxy-γ-butyrolactone having a lactone ring optionally substituted by alkyl with acrylic halide or methacrylic halide.

As monomers to be derived into structural units of the formulae (Ia) and (IIb), specifically listed are, for example, (meth)acrylates of alicyclic lactones having hydroxyl described below, and mixtures thereof, and the like. These esters can be produced, for example, by reacting corresponding alicyclic lactone having hydroxyl with (meth)acrylic acids, and the production method thereof is described in, for example, JP2000-26446-A.

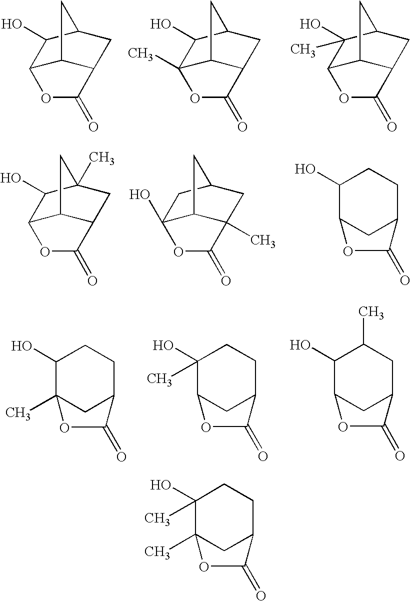

When any of the structural unit derived from 3-hydroxy-1-adamantyl (meth)acrylate, the structural unit derived from 3,5-dihydroxy-1-adamantyl (meth)acrylate, the structural unit derived from α-(meth)acryloyloxy-γ-butyrolactone, the structural unit derived from β-(meth)acryloyloxy-γ-butyrolactone and the structural unit of the formulae (IIa) and (IIb) is contained in Resin Component, not only the adhesiveness of the resist to a substrate is improved, but also the resolution of the resist is improved.

Here, examples of the (meth)acryloyloxy-γ-butyrolactone include α-acryloyloxy-γ-butyrolactone, α-methacryloyloxy-γ-butyrolactone, α-acryloyloxy-β,β-dimethyl-γ-butyrolactone, α-methacryloyloxy-β,β-dimethyl-γ-butyrolactone, α-acryloyloxy-α-methyl-γ-butyrolactone, α-methacryloyloxy-α-methyl-γ-butyrolactone, β-acryloyloxy-γ-butyrolactone, β-methacryloyloxy-γ-butyrolactone, β-methacryloyloxy-α-methyl-γ-butyrolactone and the like.

Resin Component containing a structural unit derived from 2-norbornene shows strong structure because of alicyclic group directly present on its main chain and shows a property that dry etching resistance is excellent. The structural unit derived from 2-norbornene can be introduced into the main chain by radical polymerization using, for example, in addition to corresponding 2-norbornene, aliphatic unsaturated dicarboxylic anhydrides such as maleic anhydride and itaconic anhydride together. The structural unit derived from 2-norbornene is formed by opening of its double bond, and can be represented by the formula (V). The structural unit derived from maleic anhydride and the structural unit derived from itaconic anhydride which are the structural unit derived from aliphatic unsaturated dicarboxylic anhydrides are formed by opening of their double bonds, and can be represented by the formula (VI) and the formula (VII), respectively.

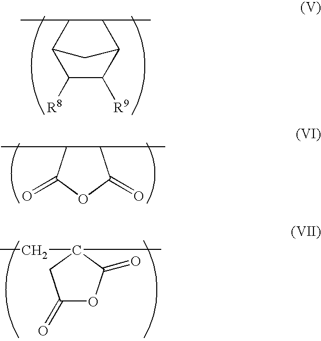

Here, R⁸ and R⁹ in the formula (V) each independently represent hydrogen, alkyl having 1 to 3 carbon atoms, hydroxyalkyl having 1 to 3 carbon atoms, carboxyl, cyano or —COOZ group in which Z represents alcohol residue, or R⁸ and R⁹ can bond together to form a carboxylic anhydride residue represented by —C(═O)OC(═O)—.

In R⁸ and R⁹, examples of the alkyl include methyl, ethyl, propyl and isopropyl, specific examples of hydroxyalkyl include hydroxymethyl, 2-hydroxyethyl and the like.

In R⁸ and R⁹, —COOZ group is an ester formed from carboxyl, and as the alcohol residue corresponding to Z, for example, optionally substituted alkyls having about 1 to 8 carbon atoms, 2-oxooxolan-3- or -4-yl and the like are listed, and as the substituent on the alkyl, hydroxyl, alicyclic hydrocarbon residues and the like are listed.

Specific examples of —COOZ include methoxycarbonyl, ethoxycarbonyl, 2-hydroxyethoxycarbonyl, tert-butoxycarbony, 2-oxooxalan-3-yloxycarbonyl, 2-oxooxalan-4-yloxycarbonyl, 1,1,2-trimethylpropoxycarbonyl, 1-cyclohexyl-1-methylethoxycarbonyl, 1-(4-methylcyclohexyl)-1-methylethoxycarbonyl, 1-(1-adamantyl)-1-methylethoxycarbonyl and the like.

Specific examples of the monomer used to derive the structural unit represented by the formula (V) may include the followings;
2-norbornene,
2-hydroxy-5-norbornene,
5-norbornen-2-carboxylic acid,
methyl 5-norbornen-2-carboxylate,
tert-butyl 5-norbornen-2-carboxylate,
1-cyclohexyl-1-methylethyl 5-norbornen-2-carboxylate,
1-(4-methylcyclohexyl)-1-methylethyl 5-norbornen-2-carboxylate,
1-(4-hydroxycyclohexyl)-1-methylethyl 5-norbornen-2-carboxylate,
1-methyl-1-(4-oxocyclohexyl)ethyl 5-norbornen-2-carboxylate,
1-(1-adamantyl)-1-methylethyl 5-norbornen-2-carboxylate,
1-methylcyclohexyl 5-norbornen-2-carboxylate,
2-methyl-2-adamantyl 5-norbornen-2-carboxylate,
2-ethyl-2-adamantyl 5-norbornen-2-carboxylate,
2-hydroxyethyl 5-norbornen-2-carboxylate,
5-norbornen-2-methanol,
5-norbornen-2,3-dicarboxylic acid anhydride, and the like.

Resin Component preferably contains the structural unit of the formula (I) generally in a ratio of 10 to 80% by mol, preferably 15 to 80% by mol in all structural units of Resin Component though the ratio varies depending on the kind of radiation for patterning exposure, the kind of an acid-labile group, and the like.

When, in addition to the structural unit of the formula (I), structural unit(s) having an acid-labile group and other structural units not easily dissociated by the action of an acid, for example, a structural unit derived from 3-hydroxy-1-adamantyl (meth)acrylate, a structural unit derived from 3,5-dihydroxy-1-adamantyl (meth)acrylate or a structural unit derived from α-(meth)acryloyloxy-γ-butyrolactone, a structural unit derived from β-(meth)acryloyloxy-γ-butyrolactone, a structural unit of the formula (IIa) or (IIb), a structural unit derived from hydroxystyrene, a structural unit of the formula (V), a structural unit derived from maleic anhydride of the formula (VI) which is a structural unit derived from an aliphatic unsaturated dicarboxylic anhydride, a structural unit derived from itaconic anhydride of the formula (VII) and the like are contained, it is preferable that the sum of these structural units is in the range of 20 to 90% by mol based on all structural units of the resin.

When 2-norbornenes and aliphatic unsaturated dicarboxylic anhydride are used as copolymerization monomer, it is preferable to use them in excess amount in view of a tendency that these are not easily polymerized.

The acid generator, another component of the positive resist composition, is that which is decomposed to generate an acid by allowing radioactive ray such as light and electron beam to act on the acid generator itself or a resist composition containing the acid generator. The acid generated from the acid generator acts on ResinComponent, to dissociate acid-labile group present in Resin Component.

Examples of the acid generator in the present resist composition include a sulfonium salt of the formula (IIIa) 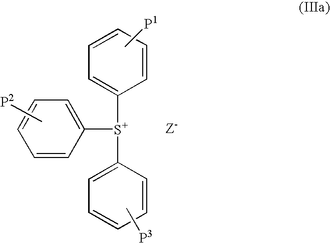
wherein P¹ to p³ each independently represent hydrogen, hydroxyl, alkyl having 1 to 6 carbon atoms or alkoxy having 1 to 6 carbon atoms, and Z⁻ represents sulfate anion,
an iodonium salt of the formula (IIIb) 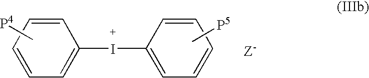
wherein P4 and P5 each independently represent hydrogen, hydroxyl, alkyl having 1 to 6 carbon atoms or alkoxy having 1 to 6 carbon atoms, and Z⁻ represents sulfate anion, or
a sulfonium salt of the formula (IIIc) 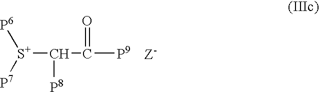
wherein p⁶ and p⁷ each independently represent alkyl having 1 to 6 carbon atoms or cycloalkyl having 3 to 10 carbon atoms, or p⁶ and p⁷ bond to form divalent acyclic hydrocarbon having 3 to 7 carbon atoms which form a ring together with the adjacent S+, and at least one —CH₂— in the divalent acyclic hydrocarbon may be substituted by —CO—, —O— or —S—; p⁸ represents hydrogen, P⁹ represents alkyl having 1 to 6 carbon atoms, cycloalkyl having 3 to 10 carbon atoms or aromatic ring group optionally substituted, or p⁸ and P⁹ bond to form 2-oxocycloalkyl together with the adjacent —CHCO—, and Z⁻ represents sulfate anion.

In p¹, p², p³, p⁴ and p⁵, specific examples of the alkyl include methyl, ethyl, propyl, isopropyl, butyl, tert-butyl, pentyl, hexyl and the like, and examples of the alkoxy include methoxy, ethoxy, propoxy, isopropoxy, butoxy, tert-butoxy and the like.

In p⁶, p⁷ and P⁹, specific examples of the alkyl include methyl, ethyl, propyl, isopropyl, butyl, tert-butyl, pentyl, hexyl and the like, and specific examples of the cycloalkyl include cyclopropyl, cyclobutyl, cyclopentyl, cyclohexyl, cycloheptyl and the like. Specific examples of the ring group formed by adjacent S⁺ and divalent acyclic hydrocarbon by p⁶ and p⁷ include pentamethylenesulfonio group, tetramethylenesulfonio group, oxybisethylenesulfonio group, and the like. In P⁹, specific examples of the aromatic ring group include phenyl, tolyl, xylyl, naphtyl and the like. Specific examples of the 2-oxocycloalkyl formed by bonding p⁸ and P⁹ together with the adjacent —CHCO— include 2-oxocyclohexyl, 2-oxocyclopentyl and the like.

Z⁻ represents a counter anion. Examples of the counter anions include alkanesulfonate, haloalkanesulfonate, halophosphate, haloborate, haloantimonate, an anion of the formula (IV) 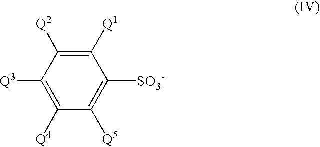
wherein Q¹, Q², Q³, Q⁴ and Q⁵ each independently represent hydrogen, alkyl having 1 to 15 carbon atoms, alkoxy having 1 to 16 carbon atoms, halogen, aryl having 6 to 12 carbon atoms, aralkyl having 7 to 12 carbon atoms, cyano, sulfide, hydroxyl, nitro or a group of the formula (IV′)
—COO—X—Cy¹ (IV′)
wherein X represents alkylene and at least one —CH₂— in the alkylene may be substituted by —O— or —S—, Cy¹ represents alicyclic hydrocarbon having 3 to 20 carbon atoms.

Examples of the optionally branched alkyl having 1 to 16 carbon atoms include methyl, ethyl, propyl, isopropyl, butyl, tert-butyl, pentyl, hexyl, octyl, decyl, dodecyl, hexadecyl, and the like.

Examples of the optionally branched alkoxy having 1 to 16 carbon atoms include methoxy, ethoxy, propoxy, isopropoxy, butoxy, tert-butoxy, pentyloxy, hexyloxy, isopentyloxy, decyloxy, dodecyloxy, hexadecyloxy, and the like.

Examples of halogen include fluorine, chlorine, bromine, iodine, and the like.

Examples of aryl having 6 to 12 carbon atoms include phenyl, tolyl, methoxyphenyl, naphtyl and the like.

Examples of the aralkyl having 7 to 12 carbon atoms include benzyl, chlorobenzyl, methoxybenzyl, and the like. When two or more of Q¹, Q², Q³, Q⁴ and Q⁵ are the groups of the formula (I′), the groups of the formula (I′) may be identical or different.

Examples of X include the followings:
—CH₂— (a-1)
—CH₂—CH₂— (a-2)
—CH₂—CH₂—CH₂— (a-3)
—CH₂—CH₂—CH₂—CH₂— (a-4)
—CH₂—CH₂—CH₂—CH₂—CH₂— (a-5)
—CH₂—CH₂—CH₂—CH₂—CH₂—CH₂— (a-6)
—CH₂—CH₂—CH₂—CH₂—CH₂—CH₂—CH₂—CH₂— (a-7)
—CH₂—O— (a-8)
—CH₂—O—CH₂— (a-9)
—CH₂—O—CH₂—CH₂— (a-10)
—CH₂—CH₂O—CH₂—CH₂— (a-11)
—CH₂—S— (a-12)
—CH₂—S—CH₂— (a-13)
—CH₂—S—CH₂—CH₂— (a-14)
—CH₂—CH₂—S—CH₂—CH₂— (a-15)

As X, (a-1) to (a-7) above are preferred.

Examples of Cy¹ include the followings:

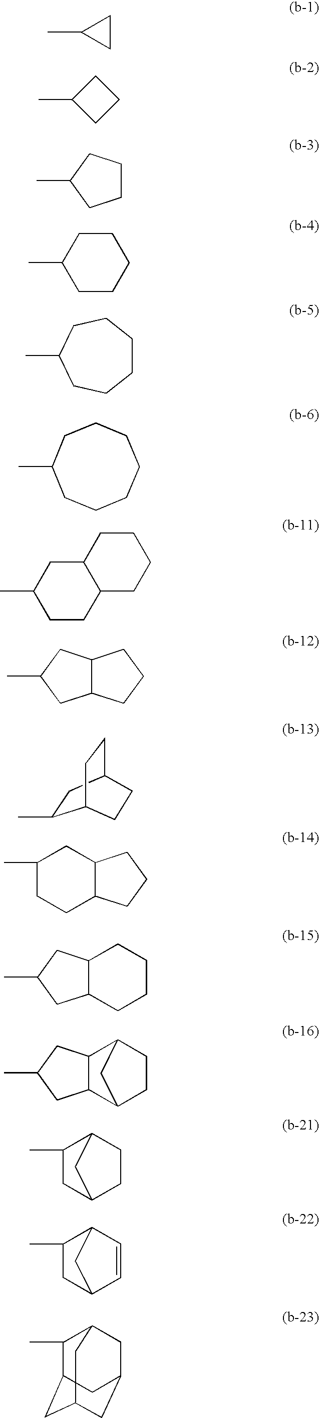

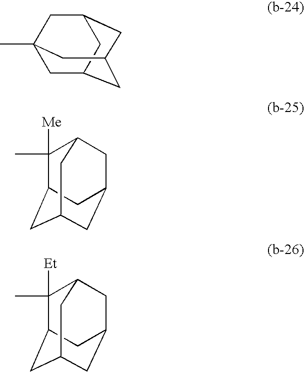

As Cy¹, cyclohexyl (b-4), 2-norbornyl (b-21), 1-adamantyl (b-24) and 2-adamantyl (b-23) are preferred.

Specific examples of cations of in the formulas (IIIa), (IIIb) or (IIIc) include the followings:

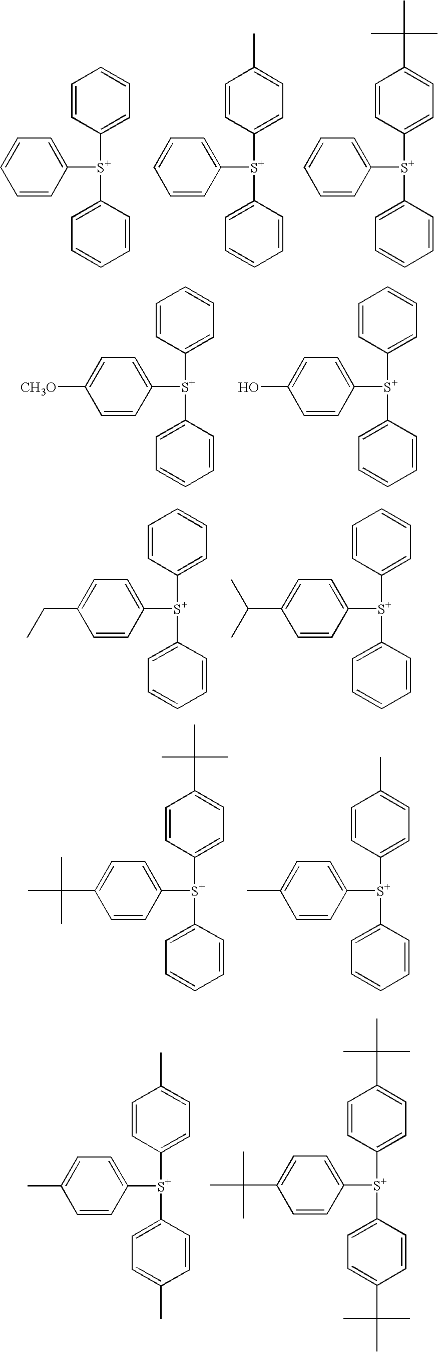

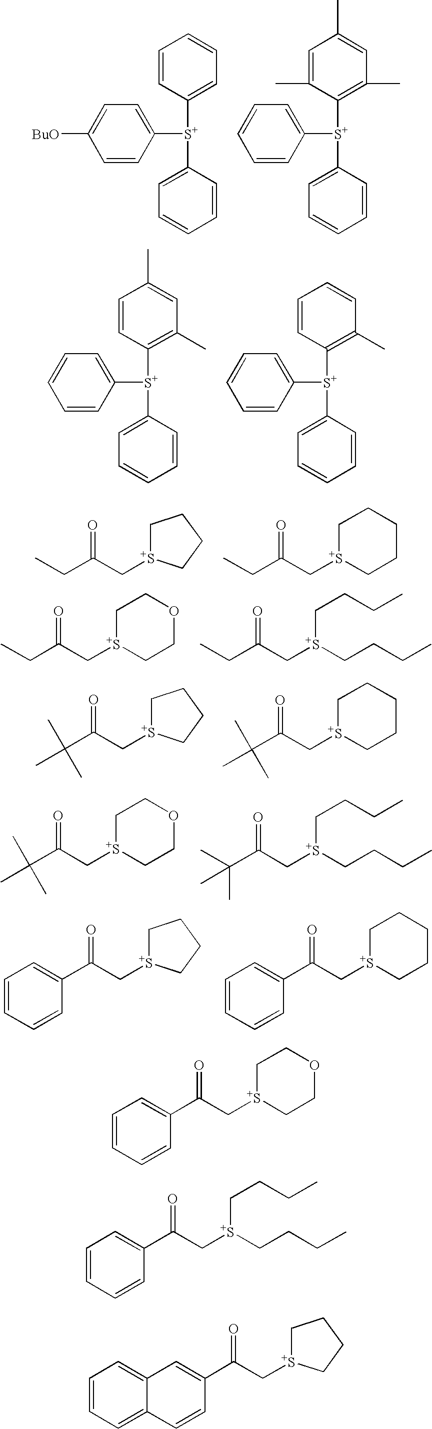

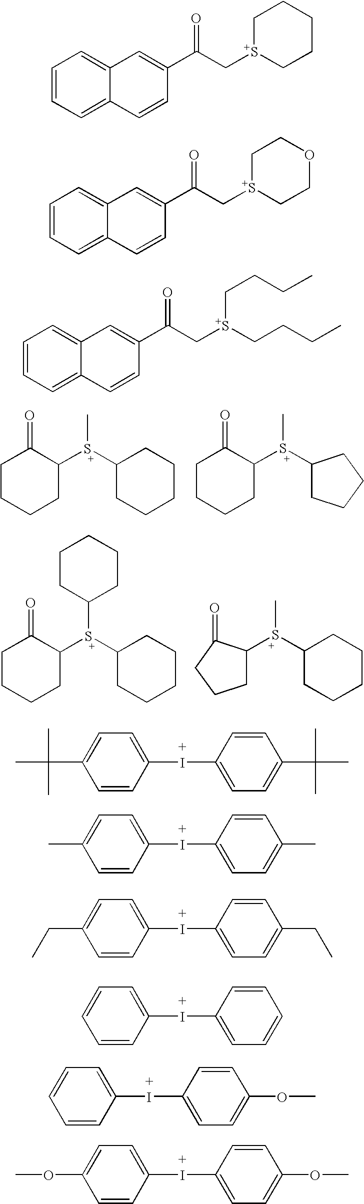

Specific examples of anion of the formula (IV) include the followings:

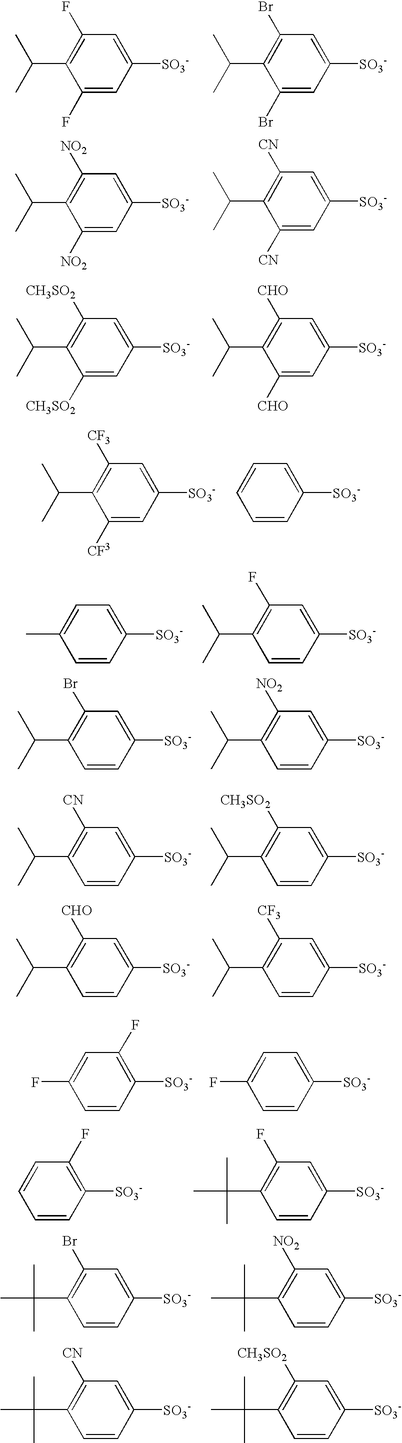

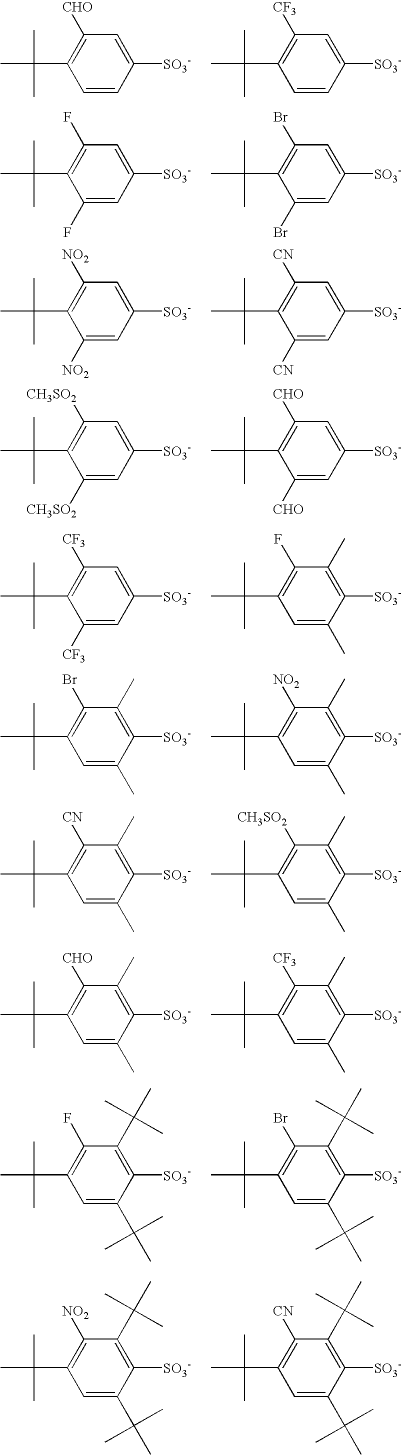

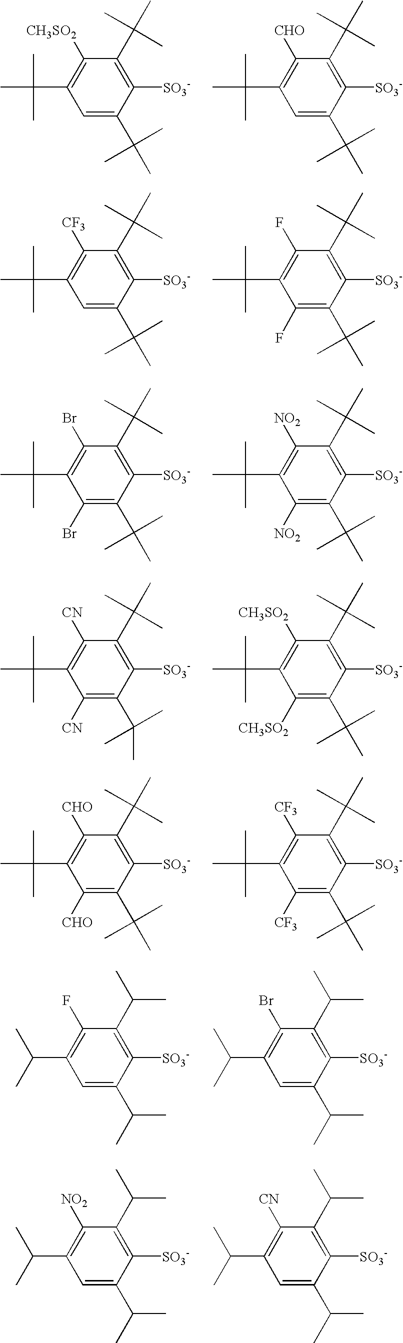

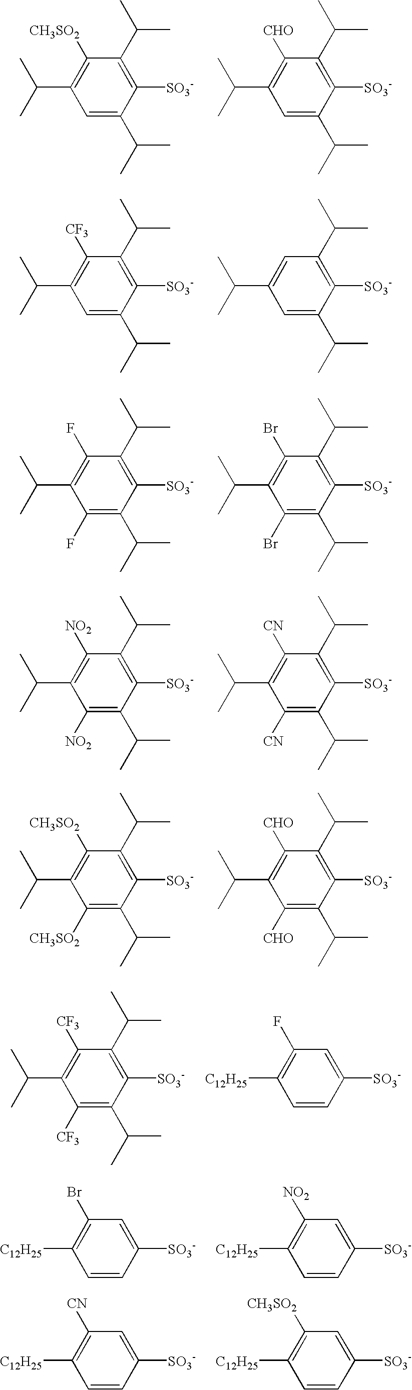

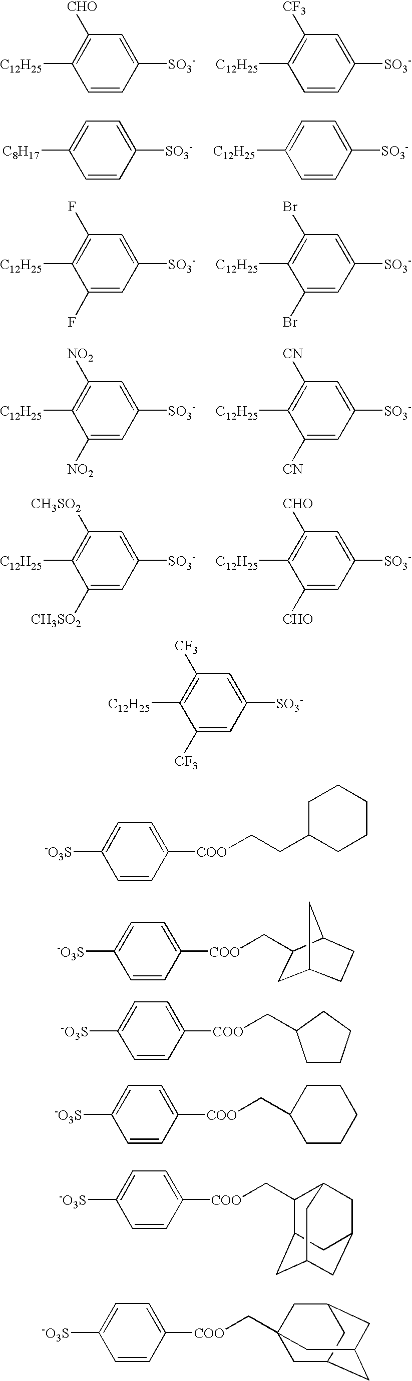

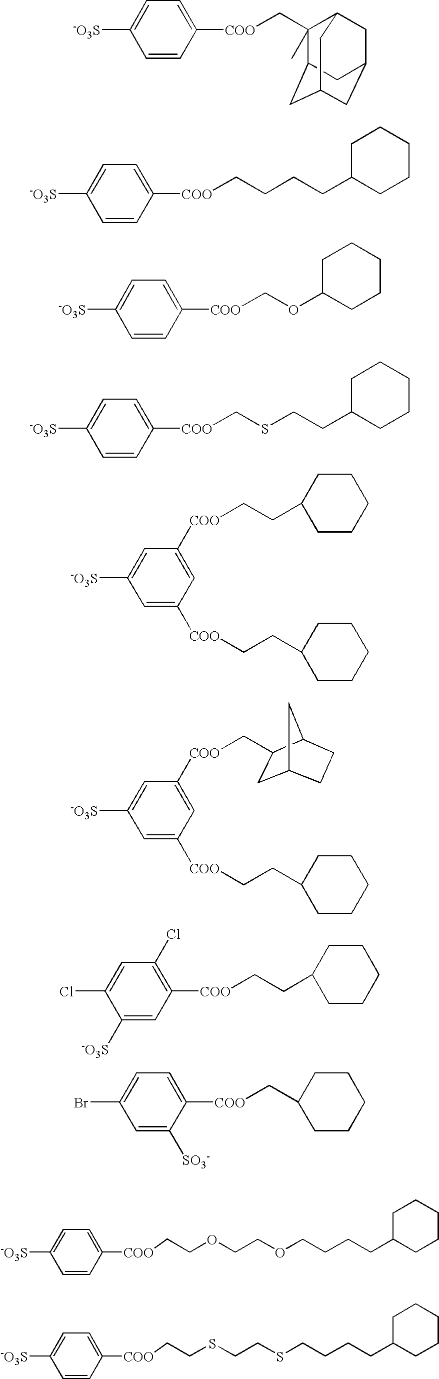

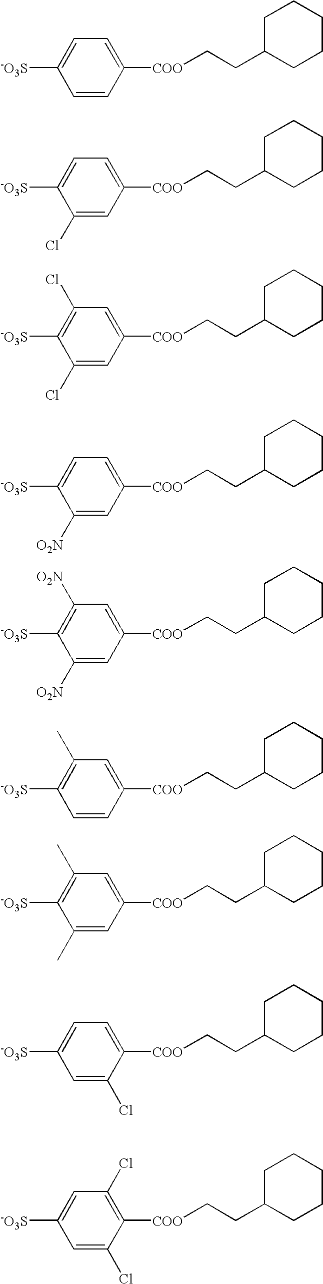

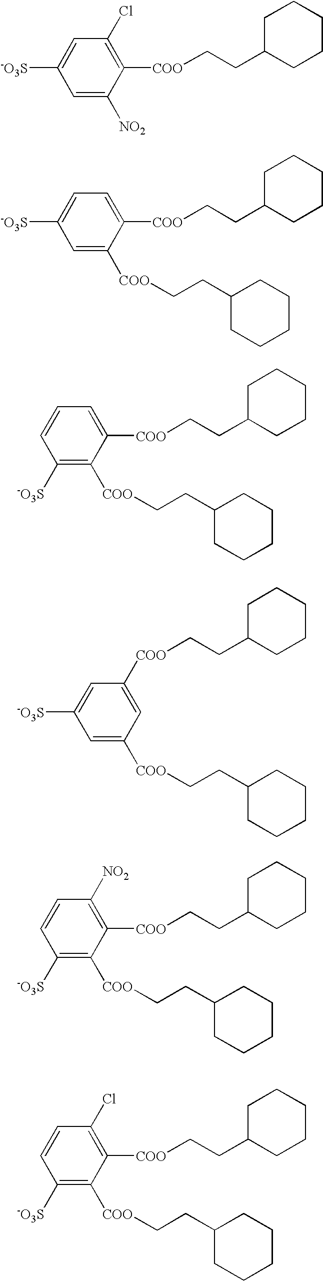

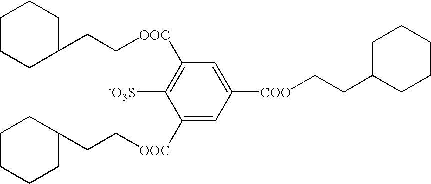

Specific examples of counter anions other than the anion of the formula (IV) include trifluoromethanesulfonate, perfluorobutanesulfonate, perfluorooctanesulfonate, hexafluoroantimonate, tetrafluoroborate, hexafluorophosphate, and the like.

The acid generator in the present resist composition can be used commercially available products, or can be produced by conventionally known method. For example, when Z is an anion of the formula (IV), the sulfonium salt of the formula (IIIa), the iodonium salt of the formula (IIIb) and the sulfonium salt of the formula (IIIc) can be produced according to conventional methods as shown below.

The sulfonium salt of the formula (IIIa) can be produced, for example, by a method reacting corresponding triphenylsulfonium bromide with silver salt of sulfonic acid having the same structure of anion part of the intended sulfonate; a method reacting corresponding aryl grignard reagent with thionyl chloride, reacting the product with triorganosilyl halide to obtain triarylsulfonium halide, and then reacting the triarylsulfonium halide with silver salt of sulfonic acid having the same structure of anion part of the intended sulfonium salt according to the method described in JP-H08-311018-A; and the like. The sulfonate in which P¹, P² or P³ in the formula (IIIa) is hydroxy, can be produced by reacting triphenylsulfonium salt having tert-butoxy on its benzene ring with sulfonic acid having the same structure of anion part of the intended sulfonium salt according to the method described in JP-H08-157451-A.

The sulfonium salt of the formula (IIIc) can be produced, for example, by a method reacting corresponding β-haloketone with corresponding sulfide compound to obtain corresponding sulfonium halide, and then reacting the corresuponding sulfonium halide and corresponding sulfonic acid or metal salt thereof having the same structure of anion part of the intended sulfonium salt applying the method described in J. Polymer Science, Polymer Chemistry Edition, Vol. 17, 2877-2892 (1979) writtern by J. V. Crivello et al.

The iodonium salt of the formula (IIIb) can be produced, for example, by a method reacting iodosyl sulfate with corresponding aryl compound, and then adding thereto corresponding sulfonic acid having the same structure of anion part of the intended iodonium salt according to a method described in J. Am. Chem. Soc., vol. 81, 342 (1959); a method adding iodine and trifluoro acetic acid to a mixture of acetic anhydride and fuming nitric acid, then reacting the reaction mixture and corresponding aryl compound, and then adding thereto corresponding sulfonic acid having the same structure of anion part of the intended iodonium salt; a method reacting a mixture of corresponding aryl compound, acetic anhydride and potassium iodate by adding drop-wise concentrated sulfuric acid thereto, and then adding thereto corresponding sulfonic acid having the same structure of anion part of the intended iodonium salt according to a method described in JP-H09-179302-A; and the like.

In the present composition, performance deterioration caused by inactivation of acid which occurs due to post exposure delay can be diminished by adding basic compounds, particularly, basic nitrogen-containing organic compounds, for example, amines as a quencher.

Specific examples of such basic nitrogen-containing organic compounds include the ones represented by the following formulae:

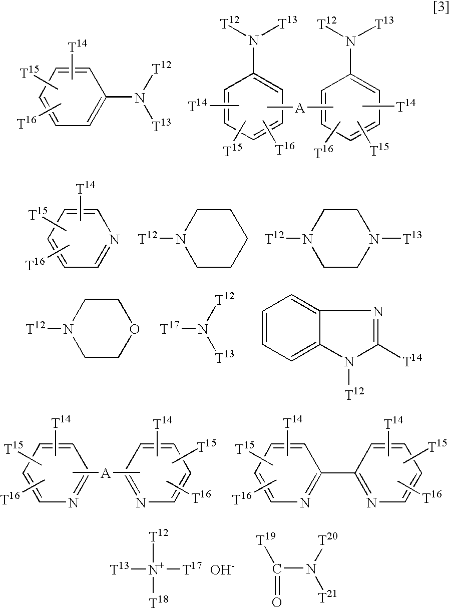

In the formulae, T¹² and T¹³ each independently represent hydrogen, alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted with hydroxyl group, amino group, or alkoxy group having 1 to 6 carbon atoms. At least one hydrogen on the amino group each independently may be substituted with alkyl group having 1 to 4 carbon atoms.

T¹⁴, T¹⁵ and T¹⁶ each independently represent hydrogen, alkyl, cycloalkyl, aryl or alkoxy. The alkyl preferably has about 1 to 6 carbon atoms, the cycloalkyl preferably has about 5 to 10 carbon atoms, the aryl preferably has about 6 to 10 carbon atoms, and the alkoxy preferably has about 1 to 6 carbon atoms. Furthermore, at least one hydrogen on the alkyl, cycloalkyl, aryl or alkoxy each independently may be substituted with hydroxyl group, amino group, or alkoxy group having 1 to 6 carbon atoms. At least one hydrogen on the amino group may be substituted with alkyl group having 1 to 4 carbon atoms.

T¹⁷ represents alkyl or cycloalkyl. The alkyl preferably has about 1 to 6 carbon atoms, and the cycloalkyl preferably has about 5 to 10 carbon atoms. Furthermore, at least one hydrogen on the alkyl or cycloalkyl may each independently be substituted with hydroxyl group, amino group, or alkoxy group having 1 to 6 carbon atoms. At least one hydrogen on the amino group may be substituted with alkyl group having 1 to 4 carbon atoms.

In the formulae, T¹⁸ represents alkyl, cycloalkyl or aryl. The alkyl preferably has about 1 to 6 carbon atoms, the cycloalkyl preferably has about 5 to 10 carbon atoms, and the aryl preferably has about 6 to 10 carbon atoms. Furthermore, at least one hydrogen on the alkyl, cycloalkyl or aryl may each independently be substituted with hydroxyl group, amino group, or alkoxy group having 1 to 6 carbon atoms. At least one hydrogen on the amino group each independently may be substituted with alkyl group having i to 4 carbon atoms.

However, none of T¹² and T¹³ in the compound represented by the above formula [3] is hydrogen.

A represents alkylene, carbonyl, imino, sulfide or disulfide. The alkylene preferably has about 2 to 6 carbon atoms.

Moreover, among T¹²-T¹⁸, in regard to those which can be straight-chained or branched, either of these may be permitted.

T¹⁹, T²⁰ and T²¹ each independently represent hydrogen, alkyl having 1 to 6 carbon atoms, aminoalkyl having 1 to 6 carbon atoms, hydroxyalkyl having 1 to 6 carbon atoms or substituted or unsubstituted aryl having 6 to 20 carbon atoms, or T¹⁹ and T²⁰ bond to form alkylene which forms a lactam ring together with adjacent CO—N—.

Examples of such compounds include hexylamine, heptylamine, octylamine, nonylamine, decylamine, aniline, 2-, 3- or 4-methylaniline, 4-nitroaniline, 1- or 2-naphtylamine, ethylenediamine, tetramethylenediamine, hexamethylenediamine, 4,4′-diamino-1,2-diphenylethane, 4,4′-diamino-3,3′-dimethyldiphenylmethane, 4,4′-diamino-3,3′-diethyldiphenylmethane, dibutylamine, dipentylamine, dihexylamine, diheptylamine, dioctylamine, dinonylamine, didecylamine, N-methylaniline, piperidine, diphenylamine, triethylamine, trimethylamine, tripropylamine, tributylamine, tripentylamine, trihexylamine, triheptylamine, trioctylamine, trinonylamine, tridecylamine, methyldibutylamine, methyldipentylamine, methyldihexylamine, methyldicyclohexylamine, methyldiheptylamine, methyldioctylamine, methyldinonylamine, methyldidecylamine, ethyldibutylamine, ethydipentylamine, ethyldihexylamine, ethydiheptylamine, ethyldioctylamine, ethyldinonylamine, ethyldidecylamine, dicyclohexylmethylamine, tris[2-(2-methoxyethoxy)ethyl]amine, triisopropanolamine, N,N-dimethylaniline, 2,6-isopropylaniline, imidazole, pyridine, 4-methylpyridine, 4-methylmidazole, bipyridine, 2,2′-dipyridylamine, di-2-pyridyl ketone, 1,2-di(2-pyridyl)ethane, 1,2-di(4-pyridyl)ethane, 1,3-di(4-pyridyl)propane, 1,2-bis(2-pyridyl)ethylene, 1,2-bis(4-pyridyl)ethylene, 1,2-bis(2-pyridyloxy)ethane, 4,4′-dipyridyl sulfide, 4,4′-dipyridyl disulfide, 1,2-bis(4-pyridyl)ethylene, 2,2′-dipicolylamine, 3,3′-dipicolylamine, tetramethylammonium hydroxide, tetraisopropylammonium hydroxide, tetrabutylammonium hydroxide, tetra-n-hexylammonium hydroxide, tetra-n-octylammonium hydroxide, phenyltrimethylammonium hydroxide, 3-trifluoromethylphenyltrimethylammonium hydroxide, (2-hydroxyethyl)trimethylammonium hydroxide (so-called “choline”), N-methylpyrrolidone, dimethylimidazole, and the like.

Furthermore, hindered amine compounds having piperidine skeleton as disclosed in JP-A-H11-52575 can be used as quencher.

It is preferable that the present composition contains Resin Component in an amount of about 80 to 99.9% by weight and the acid generator in an amount of 0.1 to 20% by weight based on the total solid content of the present composition.

When basic compound is used as a quencher, the basic compound is contained preferably in an amount of about 0.001 to 1 part by weight, more preferably in an amount of about 0.01 to 1 part by weight based on 100 parts by weight of Resin Component.

The present composition can contain, if necessary, various additives in small amount such as a sensitizer, solution suppressing agent, other resins, surfactant, stabilizer, dye and the like, as long as the effect of the present invention is not prevented.

The present composition is usually in the form of a resist liquid composition in which the aforementioned ingredients are dissolved in a solvent, and the resist liquid composition is to be applied onto a substrate such as a silicon wafer by a conventional process such as spin coating. The solvent used here is sufficient to dissolve the aforementioned ingredients, have an adequate drying rate, and give a uniform and smooth coat after evaporation of the solvent and, hence, solvents generally used in the art can be used. In the present invention, the total solid content means total content exclusive of solvents.

Examples thereof include glycol ether esters such as ethylcellosolve acetate, methylcellosolve acetate and propylene glycol monomethyl ether acetate; esters such as ethyl lactate, butyl lactate, amyl lactate and ethyl pyruvate and the like; ketones such as acetone, methyl isobutyl ketone, 2-heptanone and cyclohexanone; cyclic esters such as γ-butyrolactone, and the like. These solvents can be used each alone or in combination of two or more.

A resist film applied onto the substrate and then dried is subjected to exposure for patterning, then heat-treated for facilitating a deblocking reaction, and thereafter developed with an alkali developer. The alkali developer used here may be any one of various alkaline aqueous solutions used in the art, and generally, an aqueous solution of tetramethylammonium hydroxide or (2-hydroxyethyl)trimethylammonium hydroxide (commonly known as “choline”) is often used.

The present invention will be described more specifically by way of examples, which are not construed to limit the scope of the present invention. The “%” and “part(s)” used to represent the content of any component and the amount of any material used in the following examples are on a weight basis unless otherwise specifically noted. The weight-average molecular weight of any material used in the following examples is a value found by gel permeation chromatography using styrene as a standard reference material. Acid Generator Synthesis Example 1: Synthesis of acid generator B 1

Into a flask were charged 20 parts of 2,4,6-triisopropyl-3-nitrobenzenesulfonic acid, 80 parts of acetonitrile and 40 parts of acetone, and the mixture was stirred at room temperature for 16 hours. To this was added 7.46 parts of silver oxide, and the mixture was stirred at room temperature for 16 hours, and then filtered and concentrated to obtain 23.68 parts of silver 2,4,6-triisopropyl-3-nitrobenzenesulfonate.

Into a flask were 20 parts of silver 2,4,6-triisopropyl-3-nitrobenzenesulfonate and 185.35 parts of methanol. To this was added dropwise the mixture of 18.53 parts of p-tolyldiphenylsulfonium iodide and 185.35 parts of methanol, and then the mixture was stirred for 16 hours at room temperature. After filtration, to the filtrate was concentrated. To the concentrate was added 300 parts of chloroform, and washed with 75 parts of ion-exchanged water 3 times. The organic layer obtained was concentrated. To the concentrate was added t-butyl methyl ether for crystallization to obtain 22.07 parts of intended compound. The compound was defined as 4-methylphenyldiphenylsulfonium 2,4,6-triisopropyl-3-nitrobenzenesulfonate of the following structure by NMR (“GX-270” manufactured by JEOL Ltd.).

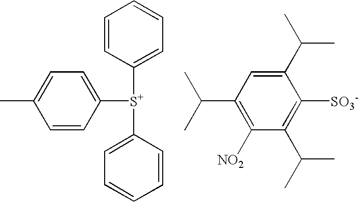

¹H-NMR (dimethylsufoxide-d₆, internal standard substance: tetramethylsilane): δ (ppm)

1.10-1.19 (m, 18H); 2.44 (s, 3H); 2.46-2.56 (m, 1H); 4.61-4.71 (m, 1H); 4.972 (br, 1H); 7.32 (s, 1H); 7.59-7.62 (m, 2H); 7.74-7.88 (m, 12H)

Acid Generator Synthesis Example 1: Synthesis of Acid Generator B2

Into a flask was charged 6 parts of 5-sulfoisophtalic acid and 50 parts of cyclohexaneethanol, and the mixture was stirred at 135 to 140° C. for 9 hours. After cooling, to this was added 50 parts of dimethylsulfoxide, 10 parts of methanol and and 200 parts of n-heptane, the mixture was stirred and settled to give two separate layers. After separating the bottom layer from the upper layer, the bottom layer was washed with n-heptane twice. The mixture obtained by correcting the upper layer and two washed n-heptane was concentrated by evaporating n-heptane and methanol. To the solution obtained was added 3.0 parts of silver oxide, and the mixture was stirred for 16 hours at room temperature. After filtration, to the filtrate was added dropwise the mixture of 8.67 parts of p-tolyldiphenylsulfonium iodide and 86.7 parts of methanol, and then the mixture was stirred for 16 hours at room temperature. After filtration, to the filtrate was 200 parts of ethyl acetate, and washed with 100 parts of water 5 times. The organic layer obtained was concentrated. The concentrate was washed with 200 parts of n-heptane and then concentrated, and the washing and concentration was repeated twice. The concentrate was washed with another 200 parts of n-heptane and then washed, concentrated and filtrated to obtain 6.24 parts of pale yellow crystals.

It was confirmed that the structure of the crystals was the following formula by NMR (“GX-270” manufactured by JEOL Ltd.) and mass spectrometry (LC analyser is No.1100 manufactured by HP, MASS analyser is LC/MSD manufactured by HP).

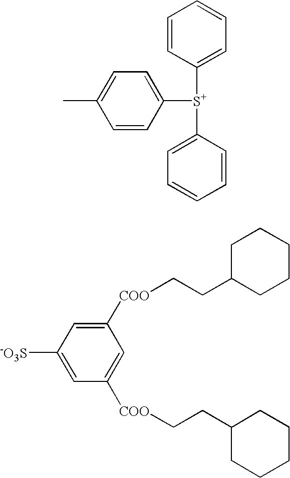

¹H-NMR (chloroform-d, internal standard substance: tetramethylsilane): δ (ppm)

0.94-1.00 (m, 4H); 1.14-1.26 (m, 6H); 1.41-1.44 (m, 2H); 1.62-1.76 (m, 14H);

2.44 (s, 3H); 4.32-4.34 (t, 4H); 7.46-7.47 (d, 2H); 7.65-7.77 (m, 12H); 8.61 (s, 1H); 8.77 (d, 2H)

MS (ESI (+) Spectrum): M+277.2

MS (ESI (−) Spectrum): M-465.2

Resin Synthesis Example 1 (Synthesis of Resin A1)

9.18 g of the monomer of the following formula (VIII), 3.33 g of 5-methacryloyloxy-2,6-norbornenelactone, and 4.73 g of α-methacryloyloxy-γ-butyrolactone (molar ratio of 50:25:25) were charged into a flask, and methyl isobutyl ketone in 2.5 times weight based on all monomers was added, and then the solution was heated to 80° C. To the solution was added azobisisobutyronitrile as an initiator in a ratio of 3 mol % based on all monomer molar amount, and the mixture was heated at 85° C. for about 5 hours. Then, operation of pouring into large amount of methanol to cause crystallization was repeated three times, and then dried to obtain 11.3 g (Yield: 65.6%) of copolymer having an average molecular weight of 5500 and molecular weight distribution of 1.79. This is called resin A1.

Resin Synthesis Example 2 (Synthesis of Resin A2)

10.0 g of the monomer of the above formula (VIII) and 7.25 g of 5-methacryloyloxy-2,6-norbornenelactone (molar ratio of 50:50) were charged into a flask, and methyl isobutyl ketone in 2.5 times weight based on all monomers was added, and then the solution was heated to 80° C. To the solution was added azobisisobutyronitrile as an initiator in a ratio of 3 mol % based on all monomer molar amount. Then, the reaction and post treatment were conducted in the same manner as in Resin snthesis example 1 to obtain 11.5 g (Yield: 66.7%) of copolymer having an average molecular weight of 19000 and molecular weight distribution of 2.02. This is called resin A2.

Resin Synthesis Example 3 (Synthesis of Resin A3)

9.18 g of the monomer of the above formula (VIII), 2.22 g of 3-hydroxy-1-adamantyl acrylate, and 12.48 g of 5-acryloyloxy-2,6-norbornenelactone (molar ratio of 30:10:60) were charged into a flask, and methyl isobutyl ketone in 2.5 times weight based on all monomers was added, and then the solution was heated to 80° C. To the solution was added azobisisobutyronitrile as an initiator in a ratio of 3 mol % based on all monomer molar amount. Then, the reaction and post treatment were conducted in the same manner as in Resin snthesis example 1 to obtain 21.4 g (Yield: 89.6%) of copolymer having an average molecular weight of 7300 and molecular weight distribution of 1.77. This is called resin A3.

Resin Synthesis Example 4 (Synthesis of Resin A4)

2-Ethyl-2-adamantyl methacrylate, 5-methacryloyloxy-2,6-norbornenelactone, and α-methacryloyloxy-γ-butyrolactone were charged at a molar ratio of 2:1:1 (11.1 g:5.0 g:3.8 g), and 50 g of 1,4-dioxane was added, to prepare solution. To the solution was added 0.30 g of azobisisobutyronitrile as an initiator, and the mixture was heated at 85° C. for about 5 hours. Then, the reaction solution was poured into large amount of n-heptane to cause precipitation, and this operation was repeated three times for purification. As a result, copolymer having a weight-average molecular weight of about 9100 and molecular weight distribution of 1.72 was obtained. This is called resin A4.

Resin Synthesis Example 5 (Synthesis of Resin A5)

2-Ethyl-2-adamantyl methacrylate and 5-methacryloyloxy-2,6-norbornanecarbolactone were charged at a molar ratio of 1:1 (12.42 g:11.11 g), and 47 g of 1,4-dioxane was added, to prepare solution. To the solution was added azobisisobutyronitrile as an initiator in a ratio of 3 mol % based on all monomer molar amount, and the mixture was heated at 80° C. for about 6 hours. Then, operation of pouring into large amount of methanol to cause crystallization was repeated three times for purification, and then dried to obtain 15.8 g (Yield: 67.1%) of copolymer having an average molecular weight of 9600 was obtained. This is called resin A5.

<Solvent>

| | |
|---|---|
| E1: propyleneglycol monomethyl ether acetate | 26 parts |
| 2-heptanone | 26 parts |
| γ-butyrolactone | 3 parts |
| E2: propyleneglycol monomethyl ether acetate | 57 parts |
| γ-butyrolactone | 3 parts |

### Examples 1 to 6 and Comparative Examples 1 and 2

The following components were mixed and dissolved, further, filtrated through a fluorine resin filter having pore diameter of 0.2 μm, to prepare resist liquid.

<Acid Generator>

B1: 4-methylphenyldiphenylsulfonium
2,4,6-triisopropyl-3-nitorobennzenesulfonate
B2: 4-methylphenyldiphenylsulfonium
3,5-bis(2-cyclohexylethoxycarbonyl)benzenesulfonate
B3: p-tolyldiphenylsulfonium perfluorooctanesulfonate
   <Resin>

Kind and amount are described in Table 1.

<Quencher>

| | |
|---|---|
| C1: 2,6-diisopropylaniline | 0.0075 part |
| <Solvent> | |
| propyleneglycol monomethyl ether acetate | 33.25 parts |
| 2-heptanone | 33.25 parts |
| γ-butyrolactone | 3.5 parts |

Silicon wafers were each coated with “ARC-29A-8”, which is an organic anti-reflective coating composition available from Brewer Co., and then baked under the conditions: 215° C., 60 seconds, to form a 780 Å-thick organic anti-reflective coating. Each of the resist liquids prepared as above was spin-coated over the anti-reflective coating so that the thickness of the resulting film became 0.30 μm in Table 2 or 0.39 μm in Tables 3 and 4 after drying. The silicon wafers thus coated with the respective resist liquids were each prebaked on a direct hotplate at temperature shown in “PB” column in Table 1 and 3 for 60 seconds. Using an ArF excimer stepper (“NSR ArF” manufactured by Nicon Corporation, NA=0.55 in Tables 1 and 2, and NA=0.55 ⅔ Annular in Talbes 3 and 4), each wafer thus formed with the respective resist film was subjected to line and space pattern exposure, with the exposure quantity being varied stepwise.

After the exposure, each wafer was subjected to post-exposure baking on a hotplate at temperature shown in “PEB” column in Tables 1 and 3 for 60 seconds and then to paddle development for 60 seconds with an aqueous solution of 2.38 wt % tetramethylammonium hydroxide.

A bright field pattern developed on the organic anti-reflective coating substrate was observed with a scanning electron microscope, the results of which are shown in Table 2. The term “bright field pattern”, as used herein, means a pattern obtained by exposure and development through a reticle comprising an outer frame made of a chromium layer (light-shielding layer) and linear chromium layers (light-shielding layers) formed on a glass surface (light-transmitting portion) extending inside the outer frame. Thus, the bright field pattern is such that, after exposure and development, resist layer surrounding the line and space pattern is removed while resist layer corresponding to the outer frame is left on the outer side of the region from which the resist layer is removed.

Effective Sensitivity:

In Table 2: It is expressed as the amount of exposure that the line pattern (light-shieldin layer) and the space pattern (light-transmitting layer) become 1:1 after exposure through 0.13 μm line and space pattern mask and development.

In Talbe 4: it is expressed as the amount of exposure that the line pattern (light-shieldin layer) and the space pattern (light-transmitting layer) become 1:1 after exposure through 0.18 μm line and space pattern mask and development.

Resolution:

It is expressed as the minimum size of space pattern which gave the space pattern split by the line pattern at the exposure amount of the effective sensitivity.

TABLE 1

| | | Acid | | | |
|---|---|---|---|---|---|
| | Resin | generator | | | |
| Example No. | (Parts) | (Parts) | Quencher | PB | PEB |
| Example 1 | A1/10 | B1/0.22 | C1 | 130° C. | 125° C. |
| Example 2 | A1/10 | B2/0.27 | C1 | 100° C. | 110° C. |
| Example 3 | A2/10 | B2/0.27 | C1 | 130° C. | 120° C. |
| Comparative | A1/10 | B2/0.27 | C1 | 140° C. | 120° C. |
| example 1 | | | | | |

TABLE 2

| | Effective | |
|---|---|---|
| | Sensitivity | Resolution |
| Example No. | (mJ/cm²) | (μm) |
| Example 1 | 36 | 0.12 |
| Example 2 | 48 | 0.12 |
| Example 3 | 45 | 0.12 |
| Comparative | 78 | 0.12 |
| example 1 | | |

TABLE 3

| | | Acid | | | |
|---|---|---|---|---|---|
| | Resin | generator | | | |
| Example No. | (Parts) | (Parts) | Quencher | PB | PEB |
| Example 4 | A1/10 | B3/0.20 | C1 | 130° C. | 110° C. |
| Example 5 | A2/10 | B3/0.20 | C1 | 130° C. | 110° C. |
| Example 6 | A3/10 | B3/0.20 | C1 | 130° C. | 100° C. |
| Comparative | A4/10 | B3/0.20 | C1 | 130° C. | 130° C. |
| example 2 | | | | | |

TABLE 4

| | Effective | |
|---|---|---|
| | Sensitivity | Resolution |
| Example No. | (mJ/cm²) | (μm) |
| Example 1 | 17 | 0.16 |
| Example 2 | 13 | 0.16 |
| Example 3 | 26 | 0.16 |
| Comparative | 20 | 0.16 |
| example 2 | | |

The chemical amplification type positive resist composition of the present invention is gives resist patterns having remarkably improved sensitivity, and excellent resist abilities such as resolution and the like. Therefore, it is suitable for excimer laser lithography using ArF, KrF and the like, has large industrial values.

1. A resin which comprises a structural unit of the formula (I) 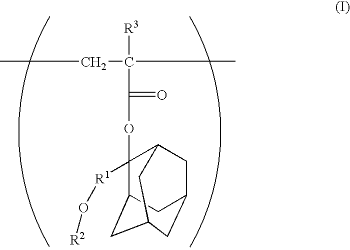
wherein R¹ represents alkylene having 1 to 4 carbon atoms, R² represents alkyl having 1 to 4 carbon atoms, and R³ represents hydrogen or methyl.

2. A chemical amplification type positive resist composition comprising a resin which comprises a structural unit of the formula (I) 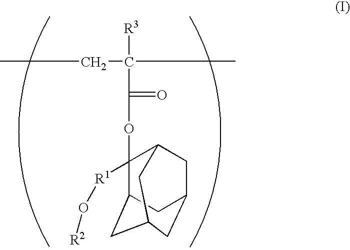
wherein R¹ represents alkylene having 1 to 4 carbon atoms, R² represents alkyl having 1 to 4 carbon atoms, and R³ represents hydrogen or methyl and which itself is insoluble or poorly soluble in an alkali aqueous solution but becomes soluble in an alkali aqueous solution by the action of an acid, and an acid generator.

3. The composition according to claim 2 wherein the content of the structural unit of the formula (I) in all structural units of the resin is from 10 to 80% by mol.

4. The composition according to claim 2 wherein the resin contains, in addition to the structural unit of the formula (I), further at least one structural unit selected from the group consisting of a structural unit derived from 3-hydroxy-1-adamantyl (meth)acrylate, a structural unit derived from 3,5-dihydroxy-1-adamantyl (meth)acrylate, a structural unit derived from (meth)acryloyloxy-γ-butyrolactone having a lactone ring optionally substituted by alkyl, a structural unit of the formula (IIa) and a structural unit of the following formula (IIb) 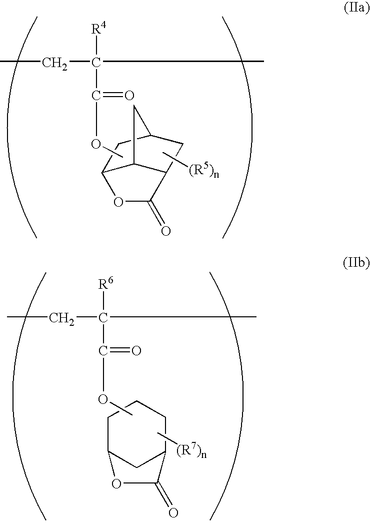
wherein R⁴ and R⁶ each independently represent hydrogen or methyl, R⁵ and R⁷ represent methyl, n represents an integer of 0 to 3.

5. The composition according to claim 2 wherein the resin further contains a structural unit derived from 2-norbornene and a structural unit derived from an aliphatic unsaturated dicarboxylic anhydride.

6. The composition according to claim 2 wherein the acid generator is the one selected from the group consisting of a sulfonium salt of the formula
(IIIa) 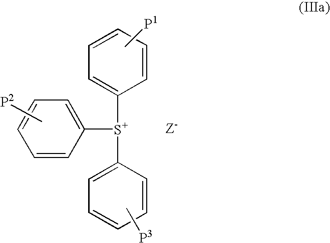
wherein P 1 to P3 each independently represent hydrogen, hydroxyl, alkyl having 1 to 6 carbon atoms or alkoxy having 1 to 6 carbon atoms, and Z⁻ represents counter anion,
an iodonium salt of the formula (IIIb) 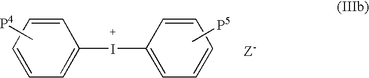
wherein P4 and P5 each independently represent hydrogen, hydroxyl, alkyl having 1 to 6 carbon atoms or alkoxy having 1 to 6 carbon atoms, and Z⁻ represents the same meaning as defined above, or
a sulfonium salt of the formula (IIIc) 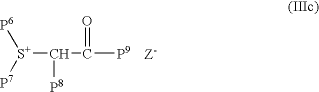
wherein p⁶ and p⁷ each independently represent alkyl having 1 to 6 carbon atoms or cycloalkyl having 3 to 10 carbon atoms, or p⁶ and p⁷ bond to form divalent acyclic hydrocarbon having 3 to 7 carbon atoms which form a ring together with the adjacent S+, and at least one —CH₂— in the divalent acyclic hydrocarbon may be substituted by —CO—, —O— or —S—; p⁸ represents hydrogen, P⁹ represents alkyl having 1 to 6 carbon atoms, cycloalkyl having 3 to 10 carbon atoms or aromatic ring group optionally substituted, or p⁸ and P⁹ bond to form 2-oxocycloalkyl together with the adjacent —CHCO—, and Z⁻ represents the same meaning as defined above.

7. The composition according to claim 6 wherein Z⁻ is an anion of the formula (IV) 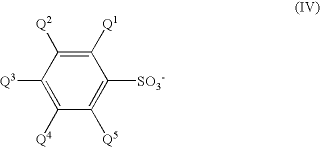
wherein Q¹, Q², Q³, Q⁴ and Q⁵ each independently represent hydrogen, alkyl having 1 to 16 carbon atoms, alkoxy having 1 to 16 carbon atoms, halogen, aryl having 6 to 12 carbon atoms, aralkyl having 7 to 12 carbon atoms, cyano, sulfide, hydroxyl, nitro or a group of the formula (I′)
—COO—X—Cy¹ (I′)
wherein X represents alkylene and at least one —CH₂— in the alkylene may be substituted by —O— or —S—, and Cy¹ represents alicyclic hydrocarbon having 3 to 20 carbon atoms.

8. The composition according to claim 2 wherein the content of the resin is 80 to 99.9% by weight and the content of the acid generator is 0.1 to 20% by weight based on the total amount of the resin and the acid generator.

9. The composition according to claim 2 wherein the composition further comprises basic nitrogen-containing organic compound as a quencher.

10. The composition according to claim 9 wherein the content of the basic nitrogen-containing organic compound is 0.001 to 1 part by weight per 100 parts by weight of the resin.
